(19) United States
(12) Patent Application Publication
(10) Pub. No.: US 2021/0071057 A1
(43) Pub. Date: Mar. 11, 2021

(54) METHOD FOR LUBRICATING UNDERGROUND CHANNELS USING ALUMINUM PHYLLOSILICATES

(71) Applicant: Kationx Corp., Dover, DE (US)

(72) Inventors: Billy Ray White, Orlando, FL (US); William Cox, Orlando, FL (US)

(73) Assignee: Kationx Corp., Dover, DE (US)

(21) Appl. No.: 16/562,134

(22) Filed: Sep. 5, 2019

(51) Int. Cl. C09K 8/14; E21B 7/04; E21B 21/06

(52) U.S. Cl. CPC C09K 8/145; E21B 21/062; E21B 7/046

(57) ABSTRACT

A method for finish a drilling operation by reducing the amount of pressure needed to pull a pipe through a borehole is provided. The method generally uses a lubricating clay composition that has a stable volume when exposed to water. The systems generally used to carry out the method comprise various boring machines, pumps, and mixing devices. The lubricating clay composition is added to water to create a drilling fluid, which may be used to lubricate the borehole and reduce the amount of wear on the boring machine as well as speed the progress of the job, especially during the completion, or pulling, phase.

### FIELD OF THE DISCLOSURE

The subject matter of the present disclosure refers generally to a process for lubricating underground channels using aluminum phyllosilicates to increase the effectiveness of drilling equipment.

### BACKGROUND

Bentonite has been called Miracle Mud and the clay of a thousand uses, and it is particularly useful as a boring mud for use in horizontal directional drilling (HDD) applications. When bentonite is mixed with fresh water, it develops an easy-to-pump clay hydrate with desirable fluid properties for HDD applications. Common additives to improve bentonite's performance are soda ash and barite. Soda ash may be used to stabilize pH of water prior to mixing with bentonite. However, soda ash is an unnecessary cost to the driller that increases the caustic behavior of any drilling fluid containing it. Barite is used as weighting agent in drilling muds, which is used to increase a downhole mud system's hydrostatic head that contains highly pressured oil—and especially gas—that may be encountered (and thus prevent well blowouts). However, barite can be a cost prohibitive addition to many drilling muds. There are also a number of polymer additives that may improve bentonite drilling mud performance, which alter the properties of the bentonite mud for specific tasks but increase disposal costs.

Therefore, it is clear there are many additives and mixtures that must be used with bentonite to make bentonite-based drilling muds perform as needed. This is because bentonite simply cannot perform to the standards needed for HDD operations (assuring wall integrity, preventing bore hold collapse, closure and soil swelling, while slickening the hole to assure smooth pipe mobility/travel) without additional additives. These engineered products added to bentonite-based drilling muds are what cause equipment corrosion as well as product build-up on clothing, equipment, skin, etc. Additionally, it can be difficult to clean clothing that comes in contact with bentonite drilling muds. Further, there are too many steps required in mixing a simple tank of boring mud, which is not cost or time effective for the operators. Therefore, although bentonite clay is the conventional, traditionally used clay for HDD operations, it also comes at a high cost to the user when paired with many of the additives currently available to make bentonite-based fluids perform as needed.

Accordingly, there is a need in the art for a process that uses a lubricating clay composition to finish a drilling operation by reducing the amount of pressure needed to pull a pipe through a borehole.

### DESCRIPTION

A process for lubricating underground channels using aluminum phyllosilicates to increase the effectiveness of drilling equipment is provided. In one aspect, the process reduces or removes utilization of bentonite, soda ash, and other poisonous chemicals currently used as drilling fluid that degrade boring machine performance over time and/or are toxic to the environment. In another aspect, the process creates a drilling mud with superior lubricating properties than drilling muds currently available. Generally, the process of the present disclosure is designed to lubricate boreholes using a lubricating clay composition that is non-corrosive to the drilling equipment and does not have to be removed from the drilling site and disposed of as a hazardous material into an approved solid waste disposal site after use. The process of the present disclosure also forms a stable emulsion that does not swell, as does bentonite which forms a clay hydrate. The systems in which the various methods herein are carried out comprise various boring machines, pumps, and mixing devices. The boring machines herein generally refer to horizontal directional drilling (HDD) devices that can change the direction in which they are drilling a hole during the drilling operation. The lubricating clay composition is added to water to create a drilling fluid, which may be used to lubricate the borehole and reduce the amount of wear on the boring machine as well as speed the progress of the job, especially during the completion, or pulling, phase.

A boring machine comprises a boring rig, drill string, drill head, and bottom hole assembly (BHA). In a preferred embodiment, the boring machine is a horizontal directional drill. In some embodiments of the boring machine, the downhole mechanical cutting action required for harder soils is provided by a mud motor. Mud motors convert hydraulic energy from drilling mud pumped from the surface to mechanical energy at the bit. This allows the bit of the drill head to rotate without the need to also rotate the drill string. In the preferred embodiment, the mud motor comprises a volume of drilling fluid (or drilling mud) that is pumped with specially designed mud pumps from the surface pits, through the drill string exiting at the drill head, up the annular space in the borehole, and back to the surface for solids removal and maintenance treatments as needed. The capacity of drilling fluid used usually is determined in part by the size of the boring machine.

Different sections of a borehole may require different drilling fluids at different stages to achieve optimal results. Drilling fluids are designed to lubricate the boring machine, support and maintain an open borehole, remove cuttings created by the boring machine during a drilling process, and lubricate the casing to facilitate its being pulled through the borehole. Because the drilling fluid is the only part of the drilling process that stays in contact with the borehole throughout the entire drilling operation, drilling-fluid selection remains one of the most important components of a successful boring operation. The ability to simulate conditions of the upper stage and lower stage of a drill hole during drilling or reducing surface friction of the borehole while increasing structural stability by simply optimizing the drilling fluid can help reduce downtime. Further, real-time management of hole conditions and the effects of a drilling fluid on the operation through data feed via the boring machine allows the operator to fine-tune drilling procedures and reduce safety risks. For instance, a higher density drilling fluid may be required in condition of the lower stage of a drill hole than in conditions for the upper stage of a drill hole as geological formations change. By changing the mix of proper drilling fluids for a particular step in a boring task,—for example, to change viscosity—an operator may maximize performance while beneficially minimizing costs throughout the borehole construction process.

Currently, bentonite is a common mineral used as a drilling mud base due to its propensity to create a thixotropic gel when mixed with water that is also effective at cooling various pieces of the boring machine. However, bentonite does not maintain a stable volume when mixed with water, which can vary the size of the boring hole over time. Bentonite clay also hardens when in a state of inactivity for an extended period of time as its viscosity increases. Therefore, bentonite-based drilling fluids must be prepared and used within a short period of time to prevent hardening on drilling equipment. Additionally, it is not uncommon to add soda ash, lime, or other caustic materials to bentonite-based drilling fluids to achieve desirable characteristics, which may cause corrosion to the boring machine over time. Further, for applications that require a high amount of lubrication, bentonite is often replaced with oil-based fluids (OBFs) and synthetic-based fluids (SBFs), which increases costs per barrel of drilling fluid as well as disposal costs. Conventional HDD practice involves finding a water source at or near the job site, collecting the needed water for mud mixing using a permitted (or too often, unpermitted) source, then collecting said water through at each source the water chemistry may vary, which in turn may drive additive use to attain desired characteristics for bentonite jells.

Using a kaolin-based drilling fluid can offset many of the negatives listed above since kaolin has friction reducing properties, maintains a stable volume when mixed with water, promotes good structural integrity of the borehole, and can be mixed more than 24 hours prior to a drilling job. Mixing the mud at the driller's yard the day before provides benefits including time savings at the job site as this task is already done, risk avoidance in not using unpermitted water sources, and consistency as make-up water is always from the same source and thus bears the same chemistry. Variations in water chemistry have been demonstrated to not effect kaolin muds. In one use in Florida, the driller successfully used hydrogen sulfide bearing water to mix a kaolin mud. In another use in Wyoming, hard water was repeatedly used to make successful kaolin mud mixes for boring jobs. Because the lubricating quality of the kaolin mud can noticeably reduce bit and drill-string wear, the cost to operate a boring machine can be reduced over time. Further, although kaolin mud may lack the gel strength which is required to suspend particles or to form a satisfactory filter cake as compared to bentonite mud, kaolin mud can be pumped at much higher viscosities. Consequently, the water loss due to poorer filter cake properties is partially mitigated by reduced seepage of the very viscous mud into the formation. In a preferred embodiment, a kaolin-based drilling fluid comprises kaolin and water. However, in other preferred embodiments, a mixture of both bentonite and kaolin may be used to create a drilling mud having properties of both the kaolin-based drilling mud and bentonite-based drilling mud.

General method steps that may be used to carry out the process of using a kaolin-based drilling fluid to pull a pipe through a borehole using a boring machine are as follows. A user may obtain a lubricating clay composition comprising kaolin. In a preferred embodiment, the lubricating clay composition does not contain bentonite or soda ash in order to maintain a steady volume, reduce the friction force of the borehole surface, and reduce the caustic behavior of the drilling fluid. The operator may then obtain water for mixing with the lubricating clay composition and mix the water and lubricating clay composition to create a drilling fluid optimized for the geological conditions in which the bore and/or pull will be performed. The operator may then add the prepared drilling fluid to the boring machine and subsequently pump said drilling fluid through the boring machine as the casing or conduit pull is being performed. This will lubricate and stabilize the borehole during the pull. The operator may recover drilling fluid at the surface of the pull operation and reuse it as needed.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other methods for carrying out the same purpose of the methods disclosed herein. Those skilled in the pertinent art should also realize that such equivalent modifications do not depart from the scope of the methods of the present disclosure.

### DESCRIPTION OF THE DRAWINGS

These and other features, aspects, and advantages of the present disclosure will become better understood with regard to the following description, appended claims, and accompanying drawings where:

FIG. 1 is a schematic of a horizontal directional drilling operation in which techniques described herein may be implemented.

FIG. 2 is a schematic of a horizontal directional drilling operation in which techniques described herein may be implemented.

FIG. 3 is a flow chart illustrating certain method steps of a method embodying features consistent with the principles of the present disclosure.

FIG. 4 is a flow chart illustrating certain method steps of a method embodying features consistent with the principles of the present disclosure.

FIG. 5 is a flow chart illustrating certain method steps of a method embodying features consistent with the principles of the present disclosure.

### DETAILED DESCRIPTION

In the Summary above and in this Detailed Description, and the Claims below, and in the accompanying drawings, reference is made to particular features, including process steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally. Where reference is made herein to a process comprising two or more defined steps, the defined steps can be carried out in any order or simultaneously (except where the context excludes that possibility), and the process can include one or more other steps which are carried out before any of the defined steps, between two of the defined steps, or after all the defined steps (except where the context excludes that possibility).

The term “comprises” and grammatical equivalents thereof are used herein to mean that other components, steps, etc. are optionally present. For example, a system “comprising” components A, B, and C can contain only components A, B, and C, or can contain not only components A, B, and C, but also one or more other components. As used herein, the term “drilling fluid” and grammatical equivalents thereof may refer to drilling mud. For instance, a bentonite-based drilling fluid is a drilling mud. As used herein, the term “borehole” and grammatical equivalents thereof may refer to drill holes. For instance, the upper stage of a drill hole is also a borehole. As used herein, the term “boring machine” and grammatical equivalents thereof may refer to different types of drilling machines. For instance, a horizontal directional drill is also a boring machine.

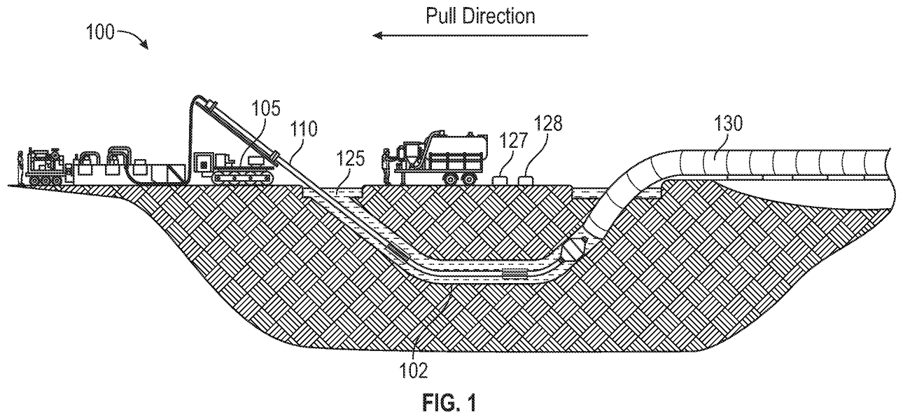

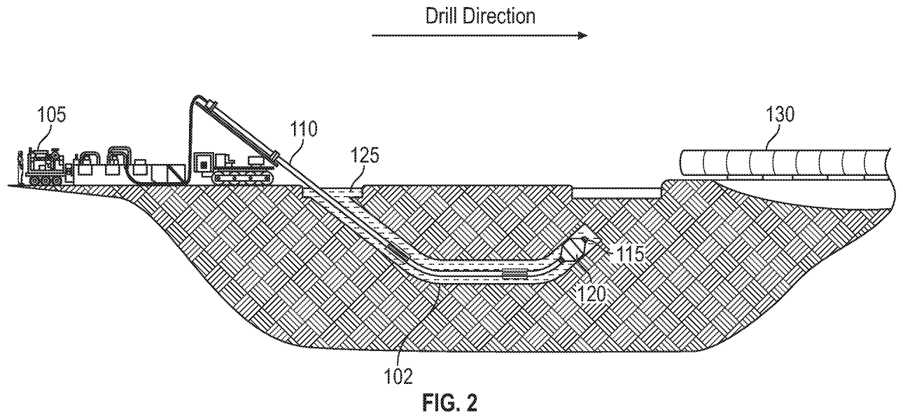

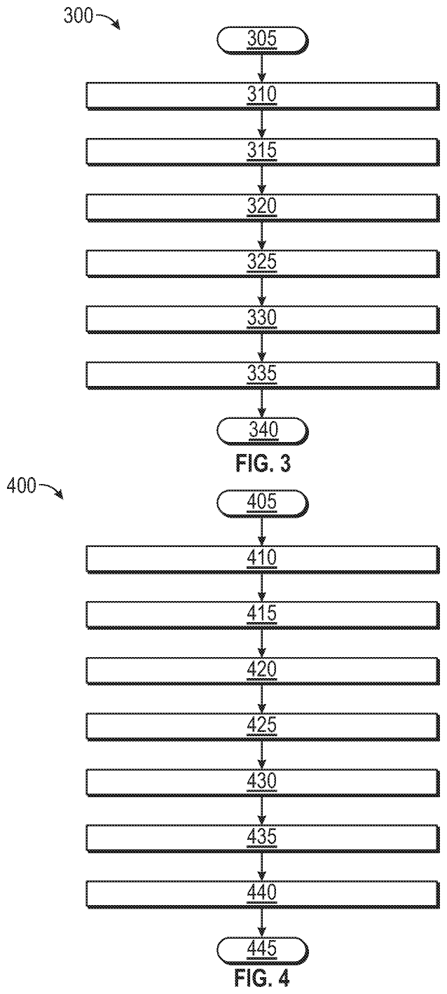

FIGS. 1-5 illustrate embodiments of a boring machine 100 and various methods for using a lubricating clay composition 127 in the drilling process. In a preferred embodiment, the lubricating clay composition 127 is a clay composition that maintains a stable volume when mixed with water and reduces the amount of friction force on the surface of a borehole 102. As illustrated in FIGS. 1 and 2, boring machines 100 may be used to create boreholes 102 and pull structures through said boreholes 102. Because the entire surface of a structure may come in contact with the surface of the created borehole 102, large friction forces may act on the structure, causing the structure to resist being pulled through the borehole 102 by the boring machine 100. Therefore, a lubricant must be applied to the surface of the borehole 102 to reduce friction. Further, the borehole 102 is not necessarily structurally stable, depending on the consistency of the material in which the boring machine 100 drilled the borehole 102 as well as numerous other factors, including, but not limited to, size, shape, etc. Therefore, the lubricating clay composition 127 must also increase the structural integrity of the borehole 102 to which it is applied. FIGS. 3-5 are flow diagrams depicting the various method steps one may take to carry out the embodiments depicted in FIGS. 1 and 2. Generally speaking, a method for lubricating a borehole 102 with a lubricating clay composition 127 comprises the steps of obtaining and lubricating clay composition 127, mixing said lubricating clay composition 127 with water, and applying said lubricating clay composition 127 to said borehole 102 as it is being drilled by the boring machine 100 or as it pulls a structure through a borehole 102.

A boring machine 100 comprises a boring rig 105, drill string 110, drill head 115, and bottom hole assembly 120 (BHA). In a preferred embodiment, the boring machine 100 is a horizontal directional drill (HDD). In some embodiments of the boring machine 100, the downhole mechanical cutting action required for harder soils is provided by a mud motor. Mud motors convert hydraulic energy from drilling mud pumped from the surface to mechanical energy at the bit. This allows the bit of the drill head 115 to rotate without the need to also rotate the drill string 110. There are two basic types of mud motors; positive displacement and turbine. Positive displacement motors are typically used in HDD applications. A positive displacement motor works via mud flow through the stationary part of the mud motor causing rotation to a rotor which in turn turns a bit connected to the rotor via some sort of linkage. In some cases, a larger diameter pipeline 130 may be rotated concentrically over the non-rotating drill string 110 to prevent sticking of the drill string 110 and allow the drill face to be freely oriented. A larger diameter pipeline 130 also maintains the borehole 102 should it be necessary to withdraw the drill string 110.

In the preferred embodiment, a mud motor comprises a volume of drilling fluid 125 (or drilling mud) that is pumped via mud pumps through the drill string 110 to the drill head 115. The mud may then return to the surface through the annular space in the borehole 102 for maintenance, including solids removal. The capacity of drilling fluid 125 used usually is determined by the size of the boring machine 100, and boring machine 100 selection is often determined by the well design. For example, the volume of drilling fluid 125 used to drill a well in the ocean may be several thousand barrels in order to fill the drilling riser that connects the rig to the seafloor. Conversely, the volume of drilling fluid 125 used to drill a shallow well on arid land may be several hundred barrels of drilling fluid 125.

Controlling the path of the drill head 115 is achieved by using a non-rotating drill string 110 with an asymmetrical leading edge. The asymmetry of the leading edge creates a steering bias that may be manipulated by the non0rotating drill string 110. If a change in direction is required, the drill string 110 is rolled so that the direction of bias is the same as the desired change in direction of the drill string 110. The drill string 110 may be continually rotated where directional control is not required. Leading edge asymmetry can be accomplished by several methods. Typically, the leading edge will have an angular offset. It is common in soft soils to achieve drilling progress by hydraulic cutting with a jet nozzle. In this case, the direction of flow from the nozzle can be offset from the central axis of the drill string 110 thereby creating a steering bias. This may be accomplished by blocking selected nozzles on a standard roller cone bit or by custom fabricating a jet deflection bit. If hard spots are encountered, the drill string 110 may be rotated to drill without directional control until the hard spot has been penetrated.

The path of the drill head 115 is monitored during drilling by taking periodic readings of the inclination and azimuth of the cutting edge of the bit via a probe. In a preferred embodiment, transmission of inclination and azimuth readings may be accomplished via a wire running inside the drill string 110 to the surface. These readings, in conjunction with measurements of the distance drilled since the last survey, are used to calculate the horizontal and vertical coordinates of the borehole 102. Because azimuth readings are taken from the earth's magnetic field and are subject to interference, the probe must be inserted in a non-magnetic collar and positioned in the string so that it is adequately isolated from potential magnetic field generators. The combination of the drill bit, mud motor, survey probe, and non-magnetic collars is referred to as the BHA 120. The path of the drill head 115 may also be tracked using a surface monitoring system. Surface monitoring systems determine the location of the probe downhole by taking measurements from a grid or point on the surface.

Once the borehole 102 has been created, it is often necessary to enlarge the hole in order to run piping through it. Enlarging the pilot hole is accomplished using either pre-reaming passes prior to pipeline installation or simultaneously during pipeline installation. The reaming assembly typically consist of a circular array of cutters and drilling fluid jets. In one preferred embodiment, an operator will pre-ream the borehole prior to installation of a pipeline 130. For a pre-reaming pass, a reaming assembly attached to the drill string 110 at the exit point is rotated and drawn to the boring rig 105, thus enlarging the pilot hole. It is also possible to ream away from the boring rig 105 by rotating and thrusting the reaming assembly away from the rig. The installation of pipeline 130 through the borehole 102 is usually accomplished by attaching the prefabricated pipeline 130 pull section behind the reaming assembly at the exit point of the borehole 102 and pulling the reaming assembly and pull section back to the drilling rig. A swivel may be used to connect the pipeline 130 pull section to the reaming assembly in order to minimize torsion transmitted to the pipeline 130.

The pipeline 130 pull section is supported using some combination of roller stands, pipeline handling equipment, or a flotation ditch to minimize tension and prevent damage to the pipeline 130. The boring mud used to create the borehole 102 can reduce the friction forces acting on the pipeline 130 pull section and reduce the amount of force necessary to pull the pipeline 130 pull section through. However, uplift forces resulting from the buoyancy the pipeline 130 pull section can be very substantial, especially for larger diameter pipelines 130. The most common method of controlling buoyancy is to fill the pipeline 130 pull section with water as it enters the hole, which requires an internal fill line to discharge water at the leading edge of the pipeline 130 pull section. In some embodiments, an air-line is needed to break the vacuum created at the cutting edge of the drill bit as the pipeline 130 pull section is pulled up to the boring rig 105.

Categories of drilling fluid 125 include, but are not limited to, freshwater, saltwater, oil, and pneumatic. Pneumatic systems most commonly are implemented in areas where formation pressures are relatively low and the risk of lost circulation or formation damage is relatively high. The use of these systems requires specialized pressure-management equipment to help prevent the development of hazardous conditions when hydrocarbons are encountered. Water-based fluids (WBFs) are the most widely used systems and are generally less expensive than oil-based fluids (OBFs) or synthetic-based fluids (SBFs) since OBFs and SBFs generally have a higher cost per gallon and disposal costs than many WBFs. Additionally, many WBFs are mud based and non-toxic, which means they pose fewer health risks to an operator. Regardless, OBFs and SBFs often are selected when bore conditions call for reliable shale inhibition and/or excellent lubricity.

As mentioned previously, different sections of a borehole 102 may require different drilling fluids 125 at different stages for optimal results. The upper stage of a drill hole is typically drilled with low-density water-based fluids. Depending on geological formation types, equipment temperatures, directional-drilling plans, and other factors, the operator might switch to an oil-based fluid or synthetic-based fluid at a predetermined point in the drilling process. For instance, a WBF having a stable volume and low grit content suitable for reducing friction forces may be required for a pull whereas a drilling fluid 125 with a more gel like consistency and good thixotropic properties might be required to drill the borehole 102. Further, depending on the location and purpose of the well, the drilling-fluid system can be contaminated or altered by saltwater flows, influxes of carbon dioxide and hydrogen sulfide, solids buildup, oil or gas influxes, extreme temperatures, spacers, cement slurries, or any combination thereof

Generally, drilling fluids 125 are designed to lubricate the boring machine 100, support the borehole 102, and remove cuttings created by the boring machine 100 during a drilling process. Because the drilling fluid 125 is the only part of the drilling process that stays in contact with the borehole 102 throughout the entire drilling operation, drilling fluid 125 selection remains one of the most important components of a successful drilling operation. The ability to simulate conditions of the upper stage and lower stage of a drill hole during drilling or reducing surface friction of the borehole 102 while increasing structural stability during a pull by simply optimizing the drilling fluid 125 can help reduce downtime. Further, real-time management of hole conditions and the effects of a drilling fluid 125 on the operation through data feed via the boring machine 100 allows the operator to fine-tune drilling procedures and reduce safety risks. For instance, a higher density drilling fluid 125 may be required in conditions of the lower stage of a drill hole in conditions of the upper stage of a drill hole as geological formations change. By choosing the proper drilling fluids 125 for a particular step in a boring task, an operator may minimize costs throughout the borehole 102 construction process.

Operators typically look for fluids that have certain characteristics, including, but not limited to, adequate suspension properties for carrying cuttings, adequate density to prevent blowouts, preserve the stability of the borehole 102, minimize formation drainage, cool and lubricate the bore string, and relay information about the borehole 102. For instance, a drilling fluid 125 used to drill the borehole 102 should have properties that help prevent or minimize the dispersion of drilled solids so that these may be removed efficiently at the surface. Otherwise, these solids may disintegrate into ultrafine particles that can impede drilling efficiency by altering the drilling fluid 125. For instance, when drilling a deep-sea well, the column of drilling fluid 125 should exert hydrostatic pressure that balances or exceed the pressure of the surrounding water as well as the natural formation pressure to help prevent the long drilling string from collapsing and prevent an influx of gas or other formation fluids. As the ocean floor depth increases and/or formation pressures increase, the density of the drilling fluid 125 should be increased to help maintain a safe margin to prevent “kicks” or “blowouts.” With large diameter HDD bores, the lower hydraulic pressures resulting from this discovery reduces the possibility of fluid excursions, breaching and surface eruptions that can damage overlying buried or surface structures. At the same time, it is important that an operator ensures that density of the fluid does not become too heavy or the formation can break down, causing it to fracture. If drilling fluid 125 is lost in these fractures, a reduction of hydrostatic pressure may occur, which could result in “kicks,” “blowouts,” or an influx from a pressurized formation. Therefore, maintaining the appropriate fluid density for the borehole 102 pressure regime is critical to safety and borehole 102 stability.

For instance, maintaining the optimal drilling-fluid density not only helps contain formation pressures, but also helps prevent hole collapse and shale destabilization. The borehole 102 should be free of obstructions and tight spots, so that the drill string 110 can be moved freely in and out of the hole (tripping). After a hole section has been drilled to the planned depth, the borehole 102 should remain stable under static conditions while casing is run to bottom and cemented. The drilling-fluid program should indicate the density and physicochemical properties most likely to provide the best results for a given interval. Drilling operations expose the producing formation to the drilling fluid 125 and any solids and chemicals contained in that fluid. Some invasion of fluid filtrate and/or fine solids into the formation is inevitable; however, this invasion and the potential for damage to the formation can be minimized with careful fluid design that is based on testing performed with cored samples of the formation of interest. Formation damage also can be curtailed by expert management of downhole hydraulics using accurate modeling software, as well as by the selection of a specially designed “drill-in” fluid, such as the systems that typically are implemented while drilling horizontal wells. For instance, the bit and drill string 110 rotate at relatively high revolutions per minute all or part of the time during actual drilling operations. The circulation of drilling fluid 125 through the drill string 110 and up the borehole 102 annular space helps reduce friction and cool the drill string 110. The drilling fluid 125 also provides a degree of lubricity to aid the movement of the drill string 110 and BHA 120 through angles that are created intentionally by directional drilling and/or through tight spots that can result from swelling shales, clays, and other rocks and/or soils. Oil-based fluids (OBFs) and synthetic-based fluids (SBFs) offer a high degree of lubricity and for this reason generally are the preferred fluid types for high-angle directional wells. Some water-based polymer systems also provide lubricity approaching that of the oil- and synthetic-based systems.

For instance, because drilling fluid 125 is in constant contact with the borehole 102, it reveals substantial information about the formations being drilled and serves as a conduit for much data collected downhole by tools located on the drill string 110 and through wireline-logging operations performed when the drill string 110 is out of the hole. The drilling fluid's 125 ability to preserve the cuttings as they travel up the annulus directly affects the quality of analysis that can be performed on the cuttings. These cuttings serve as a primary indicator of the physical and chemical condition of the drilling fluid 125. An optimized drilling-fluid system that helps produce a stable, in-gauge borehole 102 can enhance the quality of the data transmitted by downhole measurement and logging tools as well as by wireline tools.

Currently, bentonite 128 is a common mineral used to create WBFs due to its propensity to create a thixotropic gel when mixed with water that is also effective at cooling various pieces of the boring machine 100. However, bentonite 128 does not maintain a stable volume when mixed with water, which can vary the size of the boring hole over time. Bentonite 128 clay also hardens when in a state of inactivity for an extended period of time as its viscosity increases. Therefore, bentonite-based drilling fluids 125 must be prepared and used within a short period of time to prevent hardening on drilling equipment. Additionally, it is not uncommon to add soda ash, lime, or other caustic materials to bentonite-based drilling fluids 125 to achieve desirable characteristics, which may cause corrosion to the boring machine 100 over time. Further, for applications that require a high amount of lubrication, bentonite 128 is often replaced with OBFs and SBFs, which increases costs per barrel of drilling fluid 125 as well as disposal costs. Using a kaolin-based drilling fluid 125 can offset many of the negatives listed above since kaolin has friction reducing properties, maintains a stable volume when mixed with water, promotes good structural integrity of the borehole 102, and can be mixed more than 24 hours prior to a drilling job. Because the lubricating quality of the kaolin mud can noticeably reduce bit and drill- string wear, the cost to operate a boring machine 100 can be reduced over time. Further, although kaolin mud may lack the gel strength which is required to suspend particles or to form a satisfactory filter cake as compared to bentonite 128 mud, kaolin mud can be pumped at much higher viscosities. Consequently, the water loss due to poorer filter cake properties is partially mitigated by reduced seepage of the very viscous mud into the formation. In a preferred embodiment, a kaolin-based drilling fluid 125 comprises kaolin and water. However, in other preferred embodiments, a mixture of both bentonite 128 and kaolin may be used to create a drilling mud having properties of both the kaolin-based drilling mud and bentonite-based drilling mud.

FIG. 3 provides a flow chart 300 illustrating certain, preferred method steps that may be used to carry out the process of using a kaolin-based drilling fluid 125 to pull a pipeline 130 through a borehole 102 using a boring machine 100, as illustrated in FIG. 1. Step 305 indicates the beginning of the method. During step 310, a user may obtain a lubricating clay composition 127 comprising kaolin. In a preferred embodiment, the lubricating clay composition 127 does not contain bentonite 128 or soda ash in order to maintain a steady volume, reduce the friction force of the borehole 102 surface, and reduce the caustic behavior of the drilling fluid 125 made from said lubricating clay composition 127. Water loss may be controlled by pumping a higher viscosity drilling fluid 125 than what might otherwise be obtainable via use of a bentonite-based fluid. The operator may then obtain water for mixing with the lubricating clay composition 127 during step 315. Once the lubricating clay composition 127 and water have been obtained, the operator may mix the water and lubricating clay composition 127 to create a fluid optimized for the geological conditions in which the pull will be performed during step 320. The operator may then add the prepared drilling fluid 125 to the boring machine 100 during step 325 and subsequently pump said drilling fluid 125 through the boring machine 100 as the pull is being performed during step 330. This will lubricate and stabilize the borehole 102 during the pull. As the pull is being performed, the operator may recover drilling fluid 125 at the surface of the pull operation and reuse it during step 335. Once the pull is complete, the method may proceed to the terminate method step 340.

FIG. 4 provides a flow chart 400 illustrating certain, preferred method steps that may be used to carry out the process of using a kaolin-based drilling fluid 125 containing bentonite 128 clay to drill a borehole 102 using a boring machine 100, as illustrated in FIG. 2. Step 405 indicates the beginning of the method. During step 410, a user may obtain a lubricating clay composition 127 comprising kaolin and subsequently obtain bentonite 128 during step 415. Combining bentonite 128 and kaolin allows an operator to create a drilling fluid 125 that has properties of both substances. For instance, the low solid viscosity properties of kaolin mud when combined with the filtration properties of a bentonite 128 mud yields a mud with excellent characteristics for many drilling applications that yields superior lubricating properties to drilling muds comprised of just bentonite, soda ash, and water. Further, a drilling fluid 125 comprised of bentonite 128 and kaolin are less hazardous with lower disposal costs than OBFs, SBFs, and organic polymer-based fluids. The operator may then obtain water for mixing with the lubricating clay composition 127 and bentonite 128 during step 420. Once the lubricating clay composition 127, bentonite, and water have been obtained, the operator may mix them together to create a fluid optimized for the geological conditions in which the drill will be performed during step 425. The operator may then add the prepared drilling fluid 125 to the boring machine 100 during step 430 and subsequently pump said drilling fluid 125 through the boring machine 100 as the drill is being performed during step 435. This will lubricate and stabilize the borehole 102 during the drill as well as rotate the drill head 115 during drilling operations using mud pumps. As the drill is being performed, the operator may recover drilling fluid 125 at the surface of the drill operation and reuse it during step 440. Once the drill is complete, the method may proceed to the terminate method step 445. In one preferred embodiment, mud not used during the drilling operation may stored in the tank for use at a later time. As long as the kaolin-water emulsion is maintained by keeping the appropriate cationic clay to water ratio and by keeping the lubricating clay composition 127 suspended within the water, the drilling fluid 125 remains useable. This is unlike bentonite which forms a concrete solid if not used quickly, and as such it cannot be stored overnight. An emulsion created by the lubricating clay composition 127 results in less wastage, and allows for a wider range of volumes to be initially mixed. Further, unlike bentonite, which is toxic, an emulsion created by the lubricating clay composition 127 is non-toxic and inert, and as such won't harm the environment, its flora and fauna.

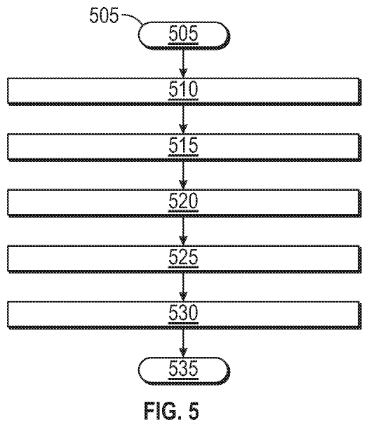

FIG. 5 provides a flow chart 500 illustrating certain, preferred method steps that may be used to carry out the process of mixing a kaolin-based drilling fluid 125 containing bentonite 128 clay, which may be used to drill a borehole 102 via a boring machine 100, as illustrated in FIG. 2. Step 505 indicates the beginning of the method. During step 510, a user may obtain a lubricating clay composition 127 comprising kaolin and subsequently obtain bentonite 128 during step 515. The operator may then obtain water for mixing with the lubricating clay composition 127 and bentonite 128 during step 520. Once the lubricating clay composition 127, bentonite, and water have been obtained, the operator may mix the bentonite 128 with water prior to the lubrication clay composition during step 525. Addition of the bentonite 128 to water prior to addition of the lubricating clay composition 127 will allow the operator to optimize the gel and thixotropic properties of the drilling fluid 125 that might otherwise be altered by the clays of the lubricating clay composition 127. Once the operator has mixed the bentonite 128 with water to create a bentonite-water mixture with the appropriate gel and thixotropic properties, the operator may mix the lubricating clay composition 127 with the bentonite-water mixture to create a drilling fluid 125 with a higher density and increased lubrication properties during step 530. Once the lubricating clay composition 127 has been thoroughly mixed with the bentonite-water mixture to create a drilling fluid 125 with the desired properties, the method may proceed to the terminate method step 535. In some embodiments of a method for making a drilling fluid 125 comprising bentonite 128 and a lubricating clay composition 127, the water used to create the fluid may be prepared in a way that alters the pH and lowers the mineral content. This may enhance the gel and thixotropic properties of the bentonite-water mixture by allowing the bentonite 128 to fully hydrate prior to addition of the lubricating clay composition 127.

Although the systems and processes of the present disclosure have been discussed for use within the well drilling field, one of skill in the art will appreciate that the inventive subject matter disclosed herein may be utilized in other fields or for other applications in which drilling fluid 125 is needed. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results unless otherwise stated. It will be readily understood to those skilled in the art that various other changes in the details, materials, and arrangements of the parts and process stages which have been described and illustrated in order to explain the nature of this inventive subject matter can be made without departing from the principles and scope of the inventive subject matter.

What is claimed is:

1. A process for lubricating boreholes while performing a pull, wherein said process comprises the steps of:
obtaining a lubricating clay composition,
wherein said lubricating clay composition maintains a stable volume when mixed with water,
obtaining water to mix with said lubricating clay composition,
mixing said lubricating clay composition with said water to create a drilling fluid,
adding said drilling fluid to a boring machine,
pumping said drilling fluid through said boring machine and into the borehole to lubricate and stabilize said borehole, and
recovering said drilling fluid from said borehole,
pulling a structure through the borehole,
wherein said drilling fluid lubricates said borehole and reduces friction acting on said structure as said structure moves through said borehole.

2. The process of claim 1, wherein said lubricating clay composition does not include bentonite clay or soda ash.

3. The process of claim 1, wherein said water is hydrogen bonded to holes of a silicate layer of said lubricating clay composition.

4. The process of claim 1, wherein said lubricating clay composition is non-corrosive to the boring machine.

5. The process of claim 1, wherein said drilling fluid comprises at least eighty weight percent lubricating clay composition and up to twenty weight percent water.

6. The process of claim 1, wherein said boring machine is a horizontal directional drilling device.

7. The process of claim 1, wherein said drilling fluid is mixed at least twenty-four hours prior to drilling.

8. The process of claim 1, wherein said lubricating clay composition comprises kaolin.

9. The process of claim 8, wherein said kaolin has a particle size between 12 and 100 microns.

10. A process for lubricating boreholes, wherein said process comprises the steps of:
obtaining a lubricating clay composition,
wherein said lubricating clay composition maintains a stable volume when mixed with water,
wherein said water is hydrogen bonded to holes of a silicate layer of said lubricating clay composition,
obtaining water to mix with said lubricating clay composition,
mixing lubricating clay composition with water to create a drilling fluid,
adding said drilling fluid to a boring machine,
pumping said drilling fluid through said boring machine and into the borehole to lubricate and stabilize the borehole while drilling, and
recovering said drilling fluid from said borehole.

11. The process of claim 10, further comprising the steps of,
obtaining bentonite clay,
adding said bentonite clay to said drilling fluid.

12. The process of claim 10, wherein said lubricating clay composition is non-corrosive to the boring machine

13. The process of claim 10, wherein said drilling fluid comprises at least 50 lbs. of lubricating clay composition per two hundred to three hundred and fifty gallons of water.

14. The process of claim 10, wherein said boring machine pulls a structure through the borehole, wherein said drilling fluid lubricates said borehole and reduces friction acting on said structure as said structure moves through said borehole.

15. The process of claim 10, wherein said drilling fluid is mixed at least twenty-four hours prior to drilling.

16. The process of claim 10, wherein said lubricating clay composition comprises kaolin.

17. The process of claim 16, wherein said kaolin has a particle size between 12 and 100 microns.

18. A process for creating a drilling fluid, wherein said process comprises the steps of:
obtaining bentonite clay,
obtaining a lubricating clay composition comprising kaolin,
wherein said lubricating clay composition maintains a stable volume when mixed with water,
wherein said water is hydrogen bonded to holes of a silicate layer of said lubricating clay composition,
obtaining water for mixing with said bentonite clay and said lubricating clay composition,
mixing said bentonite clay with said water prior to mixing said lubricating clay composition with said water to create a bentonite-water mixture having gel properties and thixotropic properties,
mixing said lubricating clay composition with said bentonite-water mixture to create a drilling fluid.

19. The process of claim 18, further comprising the step of preparing said water to mix with said bentonite clay and said lubricating clay composition.

20. The process of claim 18, wherein said kaolin has a particle size between 12 and 100 microns.
